(19) United States
(12) Patent Application Publication
(10) Pub. No.: US 2026/0025079 A1
(43) Pub. Date: Jan. 22, 2026

(54) Controllers for Synchronous Rectification and Control Methods Thereof

(71) Applicant: Leadtrend Technology Corporation, Zhubei City (TW)

(72) Inventors: Jun-Hao HUANG, Zhubei City (TW); Tsung-Chien WU, Zhubei City (TW); Ming-Chang TSOU, Zhubei City (TW); Chun-Hsin LI, Zhubei City (TW)

(21) Appl. No.: 18/976,608

(22) Filed: Dec. 11, 2024

(30) Foreign Application Priority Data
Jul. 19, 2024 (TW) 113127220

(51) Int. Cl. H02M 3/335; H02M 1/08

(52) U.S. Cl. CPC H02M 3/33592; H02M 1/08

(57) ABSTRACT

A synchronous rectification controller controls a synchronous rectifier with a control node and a detection node. The synchronous rectification controller comprises an ON-time recorder and a differential driver. The ON-time recorder records a previous ON-time in response to a detected voltage at the detection node, and determines first and second regulation periods in an ON time of the synchronous rectifier based on the previous ON-time. The first regulation period occurs prior to the second regulation period. The differential driver drives the control node to regulate the detected voltage to first and second target voltages during the first and second regulation periods, respectively. The first and second target voltages are different from each other.

### CROSS-REFERENCE TO RELATED APPLICATION

This application claims priority to and the benefit of Taiwan Application Series Number 113127220 filed on Jul. 19, 2024, which is incorporated by reference in its entirety.

### BACKGROUND

The present disclosure relates generally to LLC converters with synchronous rectification, and more particularly to LCC converters and control methods that regulate a detected voltage at a detection node of a synchronous rectifier.

LLC converters are one type of resonant converters, which typically provides a stable output voltage, high conversion efficiency, and high output power. Generally, a resonant converter converts a DC input power source into a sinusoidal signal, and this conversion can be achieved through a switch network that supplies a square-wave voltage to a resonant tank. After filtering through the resonant tank, the fundamental component of the square-wave voltage is predominantly retained, roughly producing a sinusoidal input current. Due to the inductive effects, an AC current is generated on the secondary side of the LLC converter, and, after rectification, it can be used to establish an output power source.

LLC converters are typically used for high-power application. To improve conversion efficiency, synchronous rectification can be employed on the secondary side of an LLC converter. This involves replacing the traditionally-used rectifier diode with a power switch and a synchronous rectification controller controlling the power switch. The power switch is normally named a synchronous rectifier. Doing so can reduce or eliminate the significant power loss caused by the forward voltage of the rectifier diode when conducting large currents.

Although synchronous rectification improves conversion efficiency, it can also introduce issues that require special handling. Specially, significant current variations can amplify the effects of parasitic inductance, potentially leading erroneous detection or operation.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified. These drawings are not necessarily drawn to scale. Likewise, the relative sizes of elements illustrated by the drawings may differ from the relative sizes depicted.

The invention can be more fully understood by the subsequent detailed description and examples with references made to the accompanying drawings, wherein:

FIG. 1 illustrates an LLC converter according to an embodiment of the invention;

FIG. 2 demonstrates a control circuit according to embodiments of the invention;

FIG. 3 shows the waveforms of inductor current I_{LS1} passing through synchronous rectifier SR1, detected voltage V_{DT1} at detection node DT1, variations in certain logic values from FIG. 2, and the waveform of control signal V_{G1} at control node G1;

FIG. 4 shows the waveforms of the same signals shown in FIG. 3 when both target voltages V_{REG1} and V_{REG2} are set to be −0.18V;

FIG. 5 illustrates a synchronous rectifier and related components; and

FIGS. 6 and 7 redraw the waveforms of inductor current I_{LS1}, signal ON, and control signal V_{G1}, with adjustments for the possible impact of parasitic inductor LL1 from FIG. 5.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure, or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures, or characteristics may be combined in any suitable combinations and/or subcombinations in one or more embodiments or examples. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

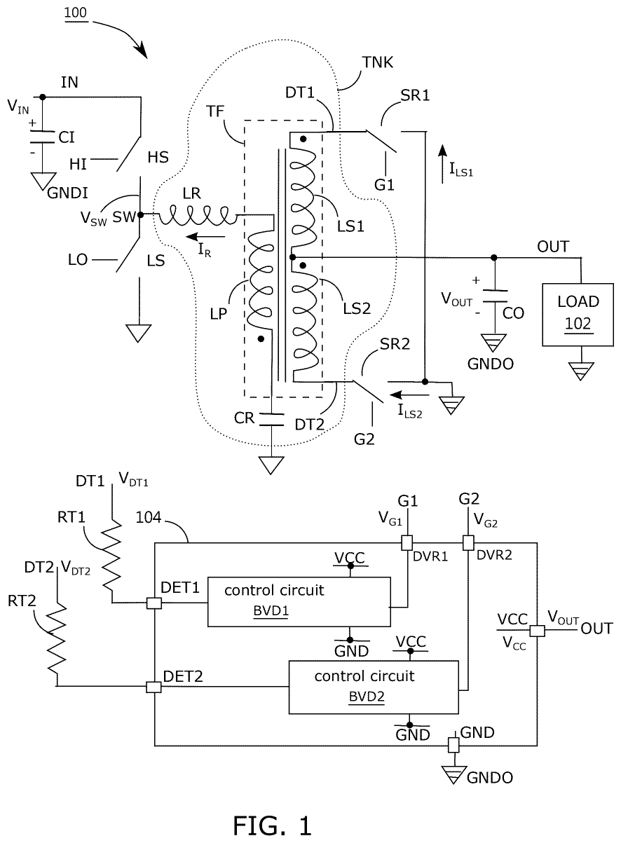

FIG. 1 illustrates LLC converter 100, which converts input power source V_{IN} on the primary side into output power source V_{OUT} on the secondary side. On the secondary side, LLC converter 100 utilizes synchronous rectification with two synchronous rectifiers SR1 and SR2, to rectify inductor currents I_{LS1} and I_{LS2} from secondary windings LS1 and LS2, respectively.

On the primary side, high-side switch HS and low-side switch are connected in series between input power line IN and input ground line GNDI, forming a half-bridge structure that functions as a square-wave generator. Filter capacitor CI, connected between input power line IN and input ground line GNDI, substantially stabilizes the voltage of input power source V_{IN}. High-side switch HS and low-side switch LS are controlled by signals HI and LO, respectively.

Resonant inductor LR, primary winding LP of transformer TF, and resonant capacitor CR are connected in series between input node SW and input ground line GNDI, forming LLC resonant tank TNK. In one embodiment, resonant inductor LR may not be a discrete component but instead the leakage inductance of primary winding LP that is not inductively coupled with secondary windings LS1 and LS2.

High-side switch HS and low-side switch LS are alternately turned on, providing a square-wave voltage to input node SW, causing LLC resonant tank TNK to resonate. An alternating current I_{R} is generated on resonant inductor LR. Through the inductively coupling of transformer TF, corresponding inductor currents I_{LS1} and I_{LS2} are generated on secondary windings LS1 and LS2, respectively. Synchronous rectifiers SR1 and SR2, two power switches, provide full-wave rectification to inductor currents I_{LS1} and I_{LS2}, where synchronous rectifiers SR1 is between output ground line GNDO and detection node DT1, and synchronous rectifiers SR2 between output ground line GNDO and detection node DT2. Filter capacitor CO provides low-pass filtering to stabilize output power source V_{OUT} between output power line OUT and output ground line GNDO. Output power source V_{OUT} supplies power to load 102. In FIG. 1, output power source V_{OUT} also functions to supply power to synchronous rectification controller 104, which controls synchronous rectifiers SR1 and SR2. The voltage at output ground line GNDO is deemed as 0V, a ground reference voltage for all voltages on the secondary side.

Resistors RT1 and RT2 connect synchronous rectification controller 104 to detection nodes DT1 and DT2, respectively. Based on detected voltage V_{DT1} and V_{DT2}, synchronous rectification controller 104 drives control nodes G1 and G2 of synchronous rectifiers SR1 and SR2. For instance, in response to detected voltage V_{DT1}, control circuit BVD1 in synchronous rectification controller 104 generates control signal V_{G1} to appropriately control synchronous rectifiers SR1.

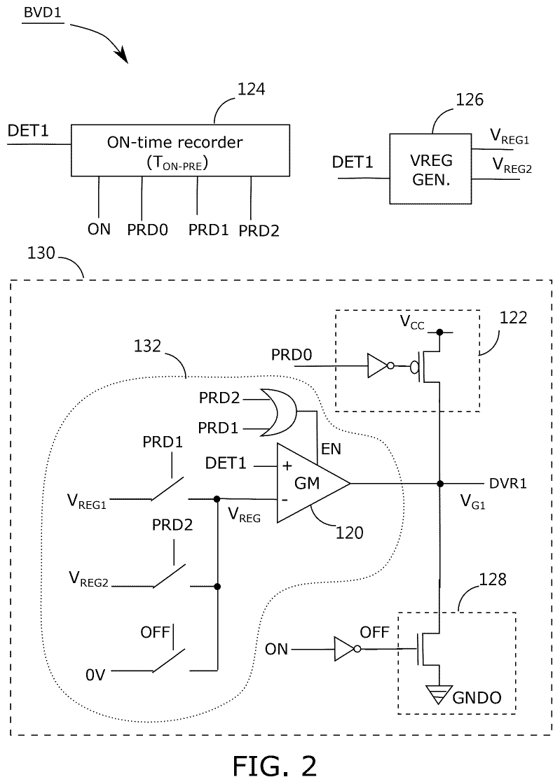

FIG. 2 demonstrates control circuit BVD1. Control circuit BVD2 could be inferred from control circuit BVD1 and might not be detailed hereinafter. As shown in FIG. 2, control circuit BVD1 includes ON-time recorder 124, target-voltage generator 126, and driver 130. ON-time recorder 124 records previous ON-time T_{ON-PRE}, which will be explained later. In response to detected voltage V_{DT1} at detection node DET1, target-voltage generator 126 provides target voltages V_{REG1} and V_{REG2} to differential amplifier 132, which accordingly generates control signal V_{G1} at control node G1.

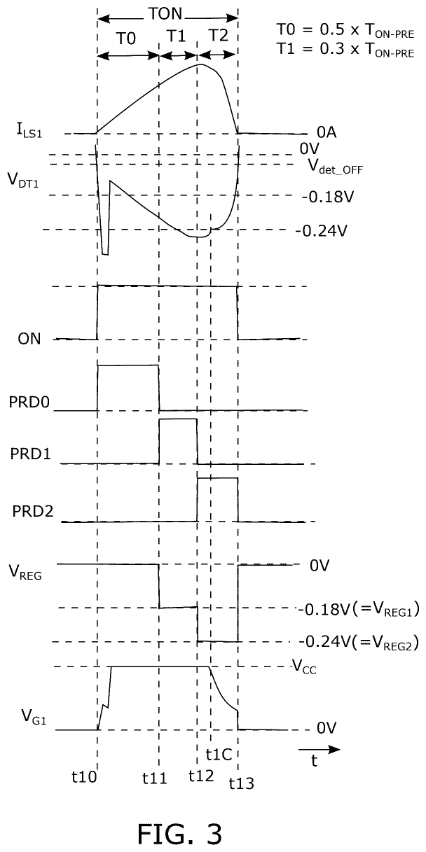

FIG. 3 shows the waveforms of inductor current I_{LS1} passing through synchronous rectifier SR1, detected voltage V_{DT1} at detection node DT1, logic changes of some signals in FIG. 2, and the waveform of control signal V_{G1} at control node G1.

Before moment t10 in FIG. 3, synchronous rectifier SR1 is at an OFF state, signal ON is “0”, control signal V_{G1} is 0V, detected voltage V_{DT1} is positive, and inductor current I_{LS1} is 0 A, with no inverse current or leakage current present.

From moment t10 to moment t13 in FIG. 3, due to the resonance of LLC resonant tank TNK, inductor current I_{LS1} is positive, and detected voltage V_{DT1} is negative. During this period, referred as ON time TON of synchronous rectifier SR1, synchronous rectifier SR1 should be turned ON to reduce the resistance in the current path, allowing inductor current I_{LS1} to flow efficiently through synchronous rectifier SR1.

ON-time recorder 124 in FIG. 2 determines the beginning and end of ON time TON based on detected voltage V_{DT1}. For example, by comparing detected voltage V_{DT1} with reference voltage V_{det_OFF}, such as −0.1V, signal ON transitions to logic “1” to indicate the beginning of ON time TON when detected voltage V_{DT1} drops below reference voltage V_{det_OFF}, as shown at moment t01 in FIG. 3. Conversely, ON-time recorder 124 makes signal ON transition to logic “0” to indicate the end of ON time TON if detected voltage V_{DT1} rises above reference voltage V_{det_OFF}, as demonstrated at moment t13 in FIG. 3.

During ON time TON, ON-time recorder 124 in FIG. 2 records previous ON-time T_{ON-PRE}, which represents the duration of ON time TON in the prior switching cycle. At moment t13 when ON time TON ends, ON-time recorder 124 updates previous ON-time T_{ON-PRE} with the duration of ON time TON.

Based on previous ON-time T_{ON-PRE}, ON-time recorder 124 divides ON time TON into fully-ON period TO, and regulation periods T1 and T2, corresponding to pulses PRD0, PRD1 and PRD2 respectively, as shown in FIG. 3. As illustrated in FIG. 3, ON-time recorder 124 starts fully-ON period TO simultaneously with the beginning of ON time TON, and ends fully-ON period TO when its duration equals half of previous ON-time T_{ON-PRE}. Regulation period T1 follows fully-ON period TO, and ends when its duration equals about three-tenths of previous ON-time T_{ON-PRE}. Regulation period T2 follows regulation period T1, and ends when ON time TON concludes. Accordingly, in a steady state, the duration of ON time TON should not change over time, the same as previous ON-time T_{ON-PRE}, so regulation period T2 is expected to last two-tenths of previous ON-time T_{ON-PRE}. Therefore, regulation periods T1 and T2 are in association with previous ON-time T_{ON-PRE}. Specially, as shown in FIG. 3, regulation period T1 starts when ON time TON reaches 50% of previous ON-time T_{ON-PRE}, and regulation period T2 begins when ON time TON reaches 80% of previous ON-time T_{ON-PRE}.

Drivers 130 controls control node G1 using different methods for fully-ON period TO and regulation periods T1 and T2. Driver 130 in FIG. 2 includes shutdown driver 128, fully-ON driver 122, and differential driver 132. Shutdown driver 128 keeps control signal V_{G1} at 0V to turn OFF synchronous rectifier SR1 and prevent the occurrence of reverse current outside ON time TON. During fully-ON period TO represented by pulse PRD0, fully-ON driver 122 forcefully pulls control signal VG1 up to a predefined voltage, such as the voltage of operation power source V_{CC} or the maximum voltage that synchronous rectifier SR1 can sustain, to minimize the ON resistance of synchronous rectifier SR1 as much as possible. During regulation period T1, transconductor 120 in differential driver 132 is enabled to compare detected voltage V_{DT1} to target voltage V_{REG1}. In this period, transconductor 120 is configured to regulate detected voltage V_{DT1} to approach target voltage V_{REG1}. Similarly, during regulation period T2, transconductor 120 is configured to regulate detected voltage V_{DT1} to approach target voltage V_{REG2}. In the embodiment shown in FIG. 3, target voltages V_{REG1} and V_{REG2} are −0.18V and −0.24V, respectively, and they appear as target signal V_{REG} at one input terminal of transconductor 120 during regulation periods T1 and T2.

FIG. 3 illustrates that control signal V_{G1} rises to operation power source V_{cc} during fully-ON period TO. During regulation period T1, control signal V_{G1} remains at operation power source V_{CC} because detected voltage V_{DT1} remains constantly below target voltage V_{REG1}, −0.18V. As a result, transconductor 120 does not pull control signal V_{G1} down during this period. Within regulation period T2, after crossing moment t1C and before moment t13, detected voltage V_{DT1} exceeds target voltage V_{REG2}, −0.24V. In response, transconductor 120 pulls down control signal V_{G1}, attempting to bring detected voltage V_{DT1} close to −0.24V.

Target-voltage generator 126 in FIG. 2 generates target voltages V_{REG1} and V_{REG2}, respectively, based on detected voltage V_{DT1}. In one embodiment, target voltages V_{REG1} and V_{REG2} are set to be −0.18V and −0.24V, respectively, when previous ON-time T_{ON-PRE} has a specific duration. However, if previous ON-time T_{ON-PRE} has a shorter duration, target voltages V_{REG1} and V_{REG2} are adjusted to −0.14V and −0.20V, respectively. According to some embodiments of the invention, target voltages V_{REG1} and V_{REG2} are determined in response to the minimum value of detected voltage V_{DT1} or the voltage of output power source V_{OUT}.

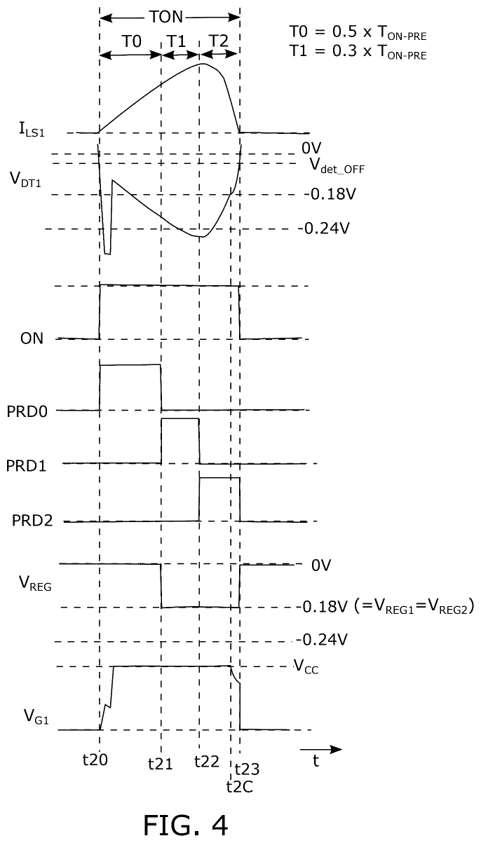

Target voltage V_{REG1} and V_{REG2} are set to be −0.18V and −0.24V in FIG. 3, respectively. FIG. 4 is similar with FIG. 3, but the embodiment for FIG. 4 has both target voltage V_{REG1} and V_{REG2} set to be −0.18V, however. As shown in FIG. 4, within regulation period T2, after crossing moment t2C and before moment t23, detected voltage V_{DT1} exceeds −0.18V and control signal V_{G1} deceases to bring detected voltage V_{DT1} closer to −0.18V. If moment t20 of FIG. 4 aligns with moment t10 of FIG. 3, moment t2c occurs behind moment t1c.

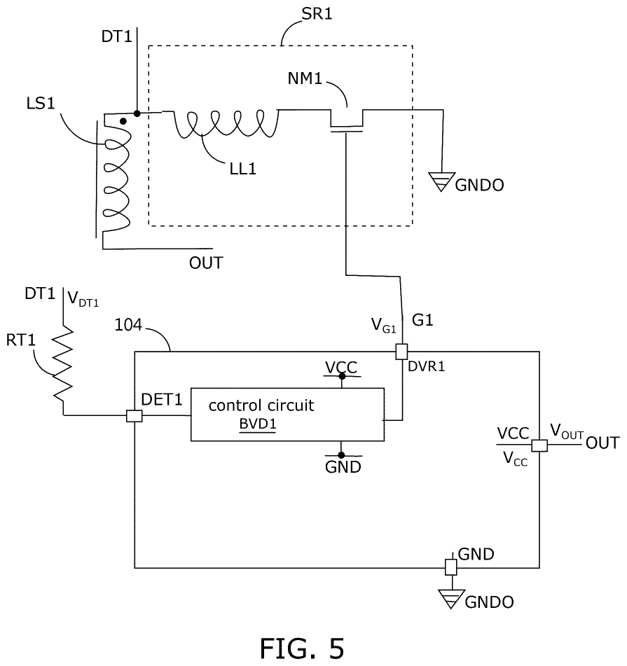

When inductor current I_{LS1} is high, parasitic inductance associated with the package pins of synchronous rectifier SR1 can significantly impact its operation. FIG. 5 illustrates synchronous rectifier SR1 and related components. In FIG. 5, synchronous rectifier SR1 includes NMOS transistor NM1 and parasitic inductor LL1, which represents the inductance of the package pins connected in series with the drain or source electrode of NMOS transistor NM1. When high-side switch HS and low-side switch LS are switched ON or OFF rapidly, the presence of parasitic inductor LL1 can cause substantial fluctuations in detected voltage V_{DT1}.

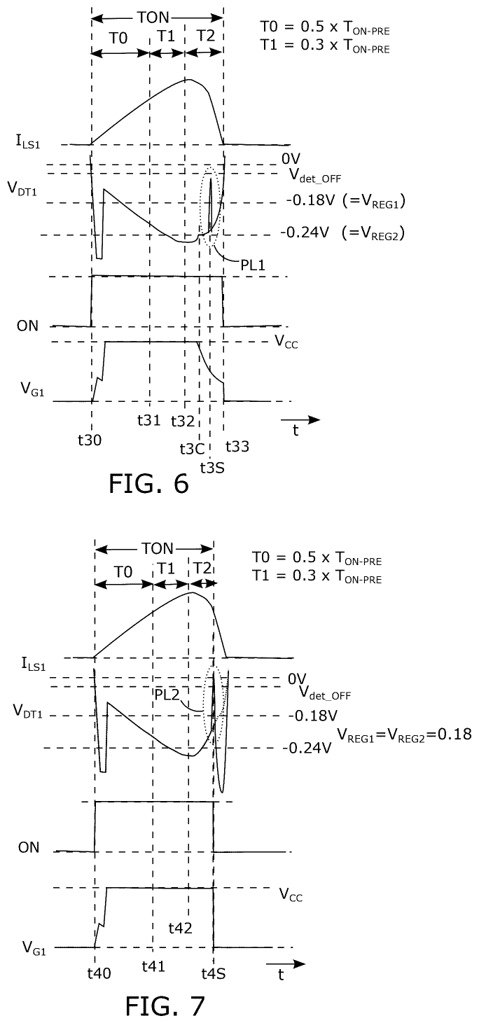

FIGS. 6 and 7 redraw the waveforms of inductor current I_{LS1}, detected voltage V_{DT1}, signal ON, and control signal V_{G1} that are shown in FIGS. 3 and 4, respectively, with adjustments for the possible impact of parasitic inductor LL1 from FIG. 5. Both switching moment t3S in FIG. 6 and switching moment t4s in FIG. 7 represent the same event when one of high-side switch HS and low-side switch LS transitions from ON to OFF. Consequently, the waveforms of detected voltage V_{DT1} in FIGS. 6 and 7 exhibit abrupt pulses PL1 and PL2 at switching moments t3S and t4S respectively, each having approximately the same amplitude due to the inductance of parasitic inductor LL1.

As shown in FIG. 6, abrupt pulses PL1 does not reach reference voltage V_{det_OFF}. Accordingly, ON time TON in FIG. 6 lasts until moment t33, identical to what is depicted in FIG. 3. The durations of ON time TON in FIGS. 6 and 3 remain the same.

Nevertheless, abrupt pulse PL2 reaches reference voltage V_{det_OFF}, causing signal ON to immediately transition into “0” in logic and ending ON time TON at switching moment t4S, as shown in FIG. 7. Compared to FIG. 4, ON time TON in FIG. 7 is significantly shorter, and it ends at the moment when inductor current I_{LS1} is still substantial, resulting in higher conduction loss.

Based on the comparison between FIGS. 6 and 7, control signal V_{G1} in FIG. 6 starts decreasing earlier at crossing moment t3C, so detected voltage V_{DT1} in FIG. 6 right before the occurring of abrupt pulse PL1 has a lower value than detected voltage V_{DT2} in FIG. 7 before abrupt pulse PL2 occurs. Consequently, unlike abrupt pulse PL2 in FIG. 7, which reaches reference voltage V_{det_OFF}, abrupt pulse PL1 in FIG. 6, starting from a lower value, does not reach reference voltage V_{det_OFF}, avoiding the higher conduction loss implied in FIG. 7.

Simply speaking, regulating detected voltage V_{DT1} to −0.18V and −0.24V in regulation periods T1 and T2 respectively helps avoiding the higher conduction loss caused by an earlier-stopped ON time TON in FIG. 7.

In some embodiments of the invention, ON time TON excludes fully-ON period TO, and consists only of regulation periods T1 and T2. In another embodiment, ON time TON includes consecutive regulation periods T1, T2, T3, . . . TN, regulating detected voltage V_{DT1} to target voltages V_{REG1}, V_{REG2}, V_{REG3}, . . . V_{REGN}, with N being an integer. All target voltages V_{REG1}, V_{REG2}, V_{REG3}, . . . V_{REGN} are negative, and each target voltage used in an earlier regulation period is always higher than that used in a later regulation period.

While the invention has been described by way of examples and in terms of preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A synchronous rectification controller for controlling a synchronous rectifier with a control node and a detection node, comprising;
an ON-time recorder for recording a previous ON-time in response to a detected voltage at the detection node, and determining first and second regulation periods in an ON time of the synchronous rectifier based on the previous ON-time, wherein the first regulation period occurs prior to the second regulation period; and
a differential driver driving the control node, for regulating the detected voltage to first and second target voltages during the first and second regulation periods respectively, wherein the first and second target voltages are different from each other.

2. The synchronous rectification controller of claim 1, wherein the synchronous rectifier has a grounded node with a ground reference voltage, and both the first and second target voltages are negative in comparison with the ground reference voltage.

3. The synchronous rectification controller of claim 2, wherein the second target voltage is lower than the first target voltage.

4. The synchronous rectification controller of claim 2, wherein the ON time includes a fully-ON period, and the synchronous rectification controller pulls a control signal at the control node up to a predefined voltage during the fully-ON period.

5. The synchronous rectification controller of claim 4, wherein the first regulation period follows the fully-ON period.

6. The synchronous rectification controller of claim 4, wherein the fully-ON period has a duration equal to a predetermined proportion of the previous ON-time.

7. The synchronous rectification controller of claim 1, wherein the first regulation period has a first duration equal to a first predetermined portion of the previous ON-time, and the second regulation period follows the first regulation period.

8. The synchronous rectification controller of claim 1, wherein the differential driver compares the detected voltage to a target signal to control the control node, and the target signal is the first and second target voltages during the first and second regulation periods respectively.

9. The synchronous rectification controller of claim 1, wherein the ON-time recorder determines an end of the ON time based on the detected voltage to update the previous ON-time.

10. A control method for controlling a synchronous rectifier on a secondary side of an LLC converter, wherein the synchronous rectifier has a control node and a detection node, and the detection node is connected to a secondary winding of a transformer, the control method comprising:
recording a previous ON-time of the synchronous rectifier in response to a detected voltage at the detection node;
turning ON the synchronous rectifier to begin an ON time of the synchronous rectifier;
determining consecutive first and second regulation periods within the ON time based on the previous ON-time; and
driving the control node of the synchronous rectifier in response to the detected voltage, wherein the detected voltage is regulated to first and second target voltages during the first and second regulation periods respectively, and the first and second target voltages are different from each other.

11. The control method of claim 10, wherein both the first and second target voltages are negative in comparison with a grounded node of the synchronous rectifier.

12. The control method of claim 10, wherein the second target voltage is lower than the first target voltage.

13. The control method of claim 10, wherein the first regulation period has a first duration equal to a first predetermined portion of the previous ON-time.

14. The control method of claim 10, comprising:
determining a fully-ON period in the ON time in response to the detected voltage and the previous ON-time; and
pulling a control signal at the control node up to a predefined voltage during the fully-ON period.

15. The control method of claim 14, wherein the fully-ON period starts simultaneously with the ON time, and has a duration equal to a predetermined proportion of the previous ON-time.

16. An LLC converter with a synchronous rectifier on a secondary side, comprising:
an LLC resonant tank driven by a square-wave generator, comprising a resonant capacitor and a primary winding connected on a primary side of the LLC converter;
a secondary winding inductively coupled to the primary winding, the secondary winding being connected in series with the synchronous rectifier through a detection node between an output power line and an output ground line; and
a synchronous rectification controller controlling the synchronous rectifier in response to a detected voltage at the detection node, the synchronous rectification controller comprising:
an ON-time recorder recording a previous ON-time in response to a detected voltage at the detection node, and determining consecutive first and second regulation periods within an ON time of the synchronous rectifier based on the previous ON-time, wherein the first regulation period occurs prior to the second regulation period; and
a differential driver driving the control node, for regulating detected voltage to first and second target voltages, wherein the first and second target voltages are different from each other.

17. The LLC converter of claim 16, wherein the second target voltage is lower than the first target voltage.

18. The LLC converter of claim 16, wherein the ON-time recorder determines a fully-ON period within the ON time, and the fully-ON period starts simultaneously with the ON time, having a duration equal to a predetermined proportion of the previous ON-time.

19. The LLC converter of claim 18, wherein the first regulation period follows the fully-ON period.

20. The LLC converter of claim 16, wherein the first regulation period has a first duration equal to a first predetermined portion of the previous ON-time.
